(19) United States
(12) Patent Application Publication
(10) Pub. No.: US 2012/0116858 A1
(43) Pub. Date: May 10, 2012

(54) CONSUMER CREATED COUPONS

(76) Inventor: Lawrence D. Simmons, JR., Edina, MN (US)

(21) Appl. No.: 13/285,812

(22) Filed: Oct. 31, 2011

Related U.S. Application Data
(60) Provisional application No. 61/410,225, filed on Nov. 4, 2010.
(60) Provisional application No. 61/418,734, filed on Dec. 1, 2010.

(51) Int. Cl. G06Q 30/02

(52) U.S. Cl. 705/14.19; 705/14.39

(57) ABSTRACT

Apparatus and a method using the apparatus to create on-line obtainable coupons include at least a first server enabling communication with a first class of third party on-line communicators having user inputs. The first server receives proposed content on coupons from the first class of third party communicators (consumers, vendees, or service users). The first server posts a list of proposed coupons, with or without modification of the proposed coupons after receipt from the first class of third-party on-line communicators. The server enables access to the server to a second class of third party communicators, which may be businesses. The server allows members of the second third party communicators to approve or disapprove of proposed coupons that are dedicated to business of the second third party communicator.

### RELATED APPLICATIONS DATA

This application claims priority from both U.S. Provisional Patent Application Ser. No. 61/410,225 filed Nov. 4, 2010, and U.S. Provisional Patent Application Ser. No. 61/418,734, filed Dec. 1, 2010.

### BACKGROUND OF THE INVENTION

1. Field of the Invention

The present invention relates to the field of coupons, the provision of coupons by vendors or merchants, and the provision of coupons through web-based services.

2. Background of the Art

The use of coupons significantly benefits both consumers and vendors by saving money for the consumers and increasing draw into a vendor's facility by the attraction of coupon available discounts on specific items. Coupons have long been available in magazines and newspapers for distribution to the public. As the use of magazines and newspapers have declined over the years, alternative methods of making coupons available have been required.

Coupons may be provided on line by direct mailing (physical mail or e-mail) from vendors or merchants or may be available from specific services that offer access to coupons at either specific stores, specific on-line services (mail order, e-mail order services, etc.), or on specific products at any location.

It is desirable to develop an additional method of providing coupons or discounts to consumers that would generate improved rates of coupon usage and minimize the provision of coupons with little commercial impact.

### SUMMARY OF THE INVENTION

Apparatus and a method using the apparatus to create on-line obtainable coupons are described and enabled. The apparatus includes at least a first server enabling communication with a first class of third party on-line communicators having user inputs. The first server receives proposed content on coupons from the first class of third party communicators, which may be consumers, vendees, service users and the like. The first server posts a list of proposed coupons, with or without modification of the proposed coupons after receipt from the first class of third-party on-line communicators. The server then enables access to the server to a second class of third party communicators, which may be businesses including at least vendors, stores, warehouses, manufacturers, distributors, retailers, wholesalers and material suppliers. The server allows members of the second third party communicators to approve or disapprove of proposed coupons that are dedicated to business of the second third party communicator. This approval may be based on response (especially from the first class of third-party on-line communicators) in the form of voting, requests, a tally of positive and negative comments, or any other indicator that shows consumer interest in a proposed coupon. The access to the consumer response is enabled by posting any second third party communicator coupons. The server may accept second third party on-line communicator approval of one or more coupons and make them available to first third-party on-line communicators. The server then allows all on-line communicators access to approved coupons so that any on-line communicators may access downloadable or printable forms of approved coupons.

### BRIEF DESCRIPTION OF THE FIGURES

FIG. 1 illustrates one embodiment of a coupon delivery system.

### DETAILED DESCRIPTION OF THE INVENTION

Apparatus and a method using the apparatus to create on-line obtainable coupons are described and enabled. The apparatus includes at least a first server enabling communication with a first class of third party on-line communicators having user inputs. The first server receives proposed content on coupons from the first class of third party communicators, which may be consumers, vendees, service users and the like. The first server posts a list of proposed coupons, with or without modification of the proposed coupons after receipt from the first class of third-party on-line communicators. The server then enables access to the server to a second class of third party communicators, which may be businesses including at least vendors, stores, warehouses, manufacturers, distributors, retailers, wholesalers and material suppliers. The server allows members of the second third party communicators to approve or disapprove of proposed coupons that are dedicated to business of the second third party communicator. This approval may be based on response (especially from the first class of third-party on-line communicators) in the form of voting, requests, a tally of positive and negative comments, or any other indicator that shows consumer interest in a proposed coupon. The access to the consumer response is enabled by posting any second third party communicator coupons. The server may accept second third party on-line communicator approval of one or more coupons and make them available to first third-party on-line communicators. The server then allows all on-line communicators access to approved coupons so that any on-line communicators may access downloadable or printable forms of approved coupons.

The technology also may include a computer readable medium that stores instructions, which when executed by a computer, causes the computer to deliver a coupon online, said instructions to the computer for:

storing information, into a coupon delivery system,

to specify at least one specific vendor and/or or product for a coupon,

to allow at least one computer to accept form at least one consumer a suggestion online for at least one specific coupon desired by the consumer,

to allow the at least one computer to accept approval by the specific vendor or distributor or manufacturer of the product authorization to enable online access to the specific coupon, and

to allow online access to the at least one computer to download a coupon or verify access to the coupon for a consumer.

The technology may further include a method of:

storing information on at least one processor in a coupon providing system; the information allowing:
a) at least one unavailable coupon proposed by a consumer or vendor;
b) allowing consumers to provide commentary on a perceived desirability of the unavailable coupon;
c) allowing a vendor, supplier or manufacturer of a product described in the coupon to authorize availability of the coupon; and
d) upon receipt of authorization by the vendor, supplier or manufacturer, enabling online access for a download of the coupon or storing verification of availability of the authorized coupon when accessed by or on behalf of a consumer.

The present technology involves Internet consumers creating and recommending promotional offers, coupons, discount or goods and services to the respective merchant via the Internet into a database which can be later displayed on a webpage or a mobile device. The invention also involves the ability for other users to vote or rally behind existing users coupons thereby creating a tally from which the merchants can review. Once that coupon is electronically submitted it remains in pending status until the merchant approves it for in-store or online redemption.

In one embodiment the coupon system 142 is adapted based on content and programs downloaded. The download-history-adapted coupon system 142 may be an implicit query 164, an active query, a disambiguation action, a retrieval function, a filtering function, a presentation function, a routing function, or another function or action relating to the initiation, processing, or completion of a search. Downloaded content and programs may be determined from a database of general characteristics (e.g., AOL users, Earthlink users, Internet Explorer users, and the like), consumer characteristics or names, or subscriber characteristics 112, such as based on cellular phone usage, computer usage, Blackberry users, PDA users, iPhone users, Internet usage, email usage or the like. Such content and programs may be analyzed and used in the manner described herein for usage pattern-adapted coupon systems 142. In one such embodiment the coupon system 142 is adapted based on specific stores (Shmata Discount Market), specific online sites, specific manufacturers (Shmata Inc.), specific lines of products (e.g., all Shmata brand facial products), specific product areas (e.g., all toothpaste). Again, the content-action-adapted coupon system 142 may be an implicit query 164, an active query, a disambiguation action, a retrieval function, a filtering function, a presentation function, a routing function, or another function or action relating to the initiation, processing, or completion of a search. In another such embodiment the coupon system 142 is adapted based on input from both consumers and suppliers/vendors/manufacturers. The consumers and suppliers/vendors/manufacturers-adapted coupon system 142 may be an implicit query 164, an active query, a disambiguation action, a retrieval function, a filtering function, a presentation function, a routing function, or another function or action relating to the initiation, processing, or completion of a search.

In another such embodiment the coupon system 142 is adapted based on subscription to a specific distributor or supplier or store name or other business sponsoring the coupons or sponsoring the coupon system. In one such embodiment the coupon system 142 is adapted based on timing and duration of viewing/downloading and other indications by consumers of a degree of positive or negative interest in use of a specifically suggested coupon.

In embodiments, a method for using the coupon delivery system may include any online communication facility 102 may include providing a personal search filter, searching for information on a network using the mobile communication facility 102, or providing results based, in part, on the communication facility 102 location and the personal search filter. The personal search filter may reside within the communication facility 102, on a server, or on a network (e.g., the Internet). A personal search filter may be a collaborative filter and may also include at least two sub filters, such as filters related to personal information, business information, selectable filters, or filters based, in part, on the time of day or time of year. Personal filters may be configurable to include a local services search engine, a local product search engine, a business search engine, personal search engine, travel search engine, financial search engine, news search engine, video search engine, music search engine, and/or restaurant search engine. The mobile communication facility 102 may be a computer, PDA, Blackberry, iPhone, cell phone, satellite phone, combination PDA/cell phone, web device, and web appliance. The communication facility 102 may include an SMS search interface, a voice recognition search interface, or wireless applications protocol. The search may be performed, in part, through a carrier website or through a carrier partner's website.

Any operating system component would be an executable program component facilitating the operation of the Information Comparator system controller. Typically, the operating system facilitates access of I/O, network interfaces, peripheral devices, storage devices, and/or the like. The operating system may be a highly fault tolerant, scalable, and secure system such as Apple Macintosh OS X (Server), AT&T Plan 9, Be OS, Linux, Unix, and/or the like operating systems. However, more limited and/or less secure operating systems also may be employed such as Apple Macintosh® OS, Microsoft® DOS, Microsoft Windows® system 2000/2003/3.1/95/98/CE/Millenium/NT/Vista/XP (Server), Palm OS, and/or the like. An operating system may communicate to and/or with other components in a component collection, including itself, and/or the like. Most frequently, the operating system communicates with other program components, user interfaces, and/or the like. For example, the operating system may contain, communicate, generate, obtain, and/or provide program component, system, user, and/or data communications, requests, and/or responses. The operating system, once executed by the CPU, may enable the interaction with communications networks, data, I/O, peripheral devices, program components, memory, user input devices, and/or the like. The operating system may provide communications protocols that allow the Information Comparator system controller to communicate with other entities through a communications network. Various communication protocols may be used by the Information Comparator system controller as a subcarrier transport mechanism for interaction, such as, but not limited to: multicast, TCP/IP, UDP, unicast, and/or the like.

### Information Server

An information server component used preferably as the computer in the above described methods and apparatus is a stored program component that is executed by a CPU. The information server may be a conventional Internet information server such as, but not limited to Apache Software Foundation's Apache, Microsoft's Internet Information Server, and/or the. The information server may allow for the execution of program components through facilities such as Active Server Page (ASP), ActiveX, (ANSI) (Objective-) C (++), C#, Common Gateway Interface (CGI) scripts, Java, JavaScript, Practical Extraction Report Language (PERL), Python, WebObjects, and/or the like. The information server may support secure communications protocols such as, but not limited to, File Transfer Protocol (FTP); HyperText Transfer Protocol (HTTP); Secure Hypertext Transfer Protocol (HTTPS), Secure Socket Layer (SSL), and/or the like. The information server provides results in the form of Web pages to Web browsers, and allows for the manipulated generation of the Web pages through interaction with other program components. After a Domain Name System (DNS) resolution portion of an HTTP request is resolved to a particular information server, the information server resolves requests for information at specified locations on the Information Comparator system controller based on the remainder of the HTTP request. For example, a request such as http://123.124.125.126/myInformation.html might have the IP portion of the request “123.124.125.126” resolved by a DNS server to an information server at that IP address; that information server might in turn further parse the http request for the “/myInformation.html” portion of the request and resolve it to a location in memory containing the information “myInformation.html.” Additionally, other information serving protocols may be employed across various ports, e.g., FTP communications across a port, and/or the like. An information server may communicate to and/or with other components in a component collection, including itself, and/or facilities of the like. Most frequently, the information server communicates with the Information Comparator system database, operating systems, other program components, user interfaces, Web browsers, and/or the like.

Access to the Information Comparator system database may be achieved through a number of database bridge mechanisms such as through scripting languages as enumerated below (e.g., CGI) and through inter-application communication channels as enumerated below (e.g., CORBA, WebObjects, etc.). Any data requests through a Web browser are parsed through the bridge mechanism into appropriate grammars as required by the Information Comparator system. In one embodiment, the information server would provide a Web form accessible by a Web browser. Entries made into supplied fields in the Web form are tagged as having been entered into the particular fields, and parsed as such. The entered terms are then passed along with the field tags, which act to instruct the parser to generate queries directed to appropriate tables and/or fields. In one embodiment, the parser may generate queries in standard SQL by instantiating a search string with the proper join/select commands based on the tagged text entries, wherein the resulting command is provided over the bridge mechanism to the Information Comparator system as a query. Upon generating query results from the query, the results are passed over the bridge mechanism, and may be parsed for formatting and generation of a new results Web page by the bridge mechanism. Such a “new results” Web page is then provided to the information server, which may supply it to the requesting Web browser.

Also, an information server may contain, communicate, generate, obtain, and/or provide program component, system, user, and/or data communications, requests, and/or responses.

User Interface

The function of computer interfaces in some respects is similar to automobile operation interfaces. Automobile operation interface elements such as steering wheels, gearshifts, and speedometers facilitate the access, operation, and display of automobile resources, functionality, and status. Computer interaction interface elements such as check boxes, cursors, menus, scrollers, and windows (collectively and commonly referred to as widgets) similarly facilitate the access, operation, and display of data and computer hardware and operating system resources, functionality, and status. Operation interfaces are commonly called user interfaces. Graphical user interfaces (GUIs) such as the Apple Macintosh Operating System's Aqua, Microsoft's Windows XP, or Unix's X-Windows provide a baseline and means of accessing and displaying information graphically to users.

A user interface component is a stored program component that is executed by a CPU. The user interface may be a conventional graphic user interface as provided by, with, and/or atop operating systems and/or operating environments such as Apple Macintosh OS, e.g., Aqua, GNUSTEP, Microsoft Windows (NT/XP), Unix X Windows (KDE, Gnome, and/or the like), mythTV, and/or the like. The user interface may allow for the display, execution, interaction, manipulation, and/or operation of program components and/or system facilities through textual and/or graphical facilities. The user interface provides a facility through which users may affect, interact, and/or operate a computer system. A user interface may communicate to and/or with other components in a component collection, including itself, and/or facilities of the like. Most frequently, the user interface communicates with operating systems, other program components, and/or the like. The user interface may contain, communicate, generate, obtain, and/or provide program component, system, user, and/or data communications, requests, and/or responses.

Web Browser

A Web browser component is a stored program component that is executed by a CPU. The Web browser may be a conventional hypertext viewing application such as Microsoft Internet Explorer or Netscape Navigator. Secure Web browsing may be supplied with 128 bit (or greater) encryption by way of HTTPS, SSL, and/or the like. Some Web browsers allow for the execution of program components through facilities such as Java, JavaScript, ActiveX, and/or the like. Web browsers and like information access tools may be integrated into PDAs, cellular telephones, and/or other mobile devices. A Web browser may communicate to and/or with other components in a component collection, including itself, and/or facilities of the like. Most frequently, the Web browser communicates with information servers, operating systems, integrated program components (e.g., plug-ins), and/or the like; e.g., it may contain, communicate, generate, obtain, and/or provide program component, system, user, and/or data communications, requests, and/or responses. Of course, in place of a Web browser and information server, a combined application may be developed to perform similar functions of both. The combined application would similarly affect the obtaining and the provision of information to users, user agents, and/or the like from the Information Comparator system enabled nodes. The combined application may be nugatory on systems employing standard Web browsers.

Mail Server

A mail server component is a stored program component that is executed by a CPU. The mail server may be a conventional Internet mail server such as, but not limited to sendmail, Microsoft Exchange, and/or the. The mail server may allow for the execution of program components through facilities such as ASP, ActiveX, (ANSI) (Objective-) C (++), CGI scripts, Java, JavaScript, PERL, pipes, Python, WebObjects, and/or the like. The mail server may support communications protocols such as, but not limited to: Internet message access protocol (IMAP), Microsoft Exchange, post office protocol (POPS), simple mail transfer protocol (SMTP), and/or the like. The mail server can route, forward, and process incoming and outgoing mail messages that have been sent, relayed and/or otherwise traversing through and/or to the Information Comparator system.

A coupon provision network typically integrates entities, such as consumers, manufacturers, suppliers, vendors, consumer outlets and the like. A coupon providing network typically operates in conjunction with suppliers and the like to deliver coupons, from one or more suppliers, vendors, consumer outlets, manufacturers advertisers, to consumers or tomcard clubs which enable access by consumers to a central database of coupons that have been anabled or authorized, with identification of the consumer to the central database of the card club needed to enable the use of the coupon. For example, Shmata manufacturing Inc. and its outlet stores, may operate such a coupon club and/or accessing network.

An integrator network entity generally defines a participant of the advertising exchange system that represents or integrates one or more entities on the coupon providing system. For example, an integrator network may represent advertisers on the coupon providing system in order to deliver coupons from vendors to consumers or other integrator networks. In some embodiments, the integrator networks are referred to as the “users” of the coupon providing system. The integrated networks may comprise third party agents that operate on behalf of or are part of the integrator network. The term “third party agent” is used to generally describe an agent or customer that participates in transactions on the coupon providing system. Similarly, the term “third party recipient” is used to describe a user or participant of the coupon providing system that receives information from the system, such as coupon requests. However, the terms integrator networks, third party agents and third party recipients is intended to represent a broad class of entities, including all commercial parties that sell, lease, rent, provide services and the like, as well as the agents that represent them, that operate on the coupon providing system.

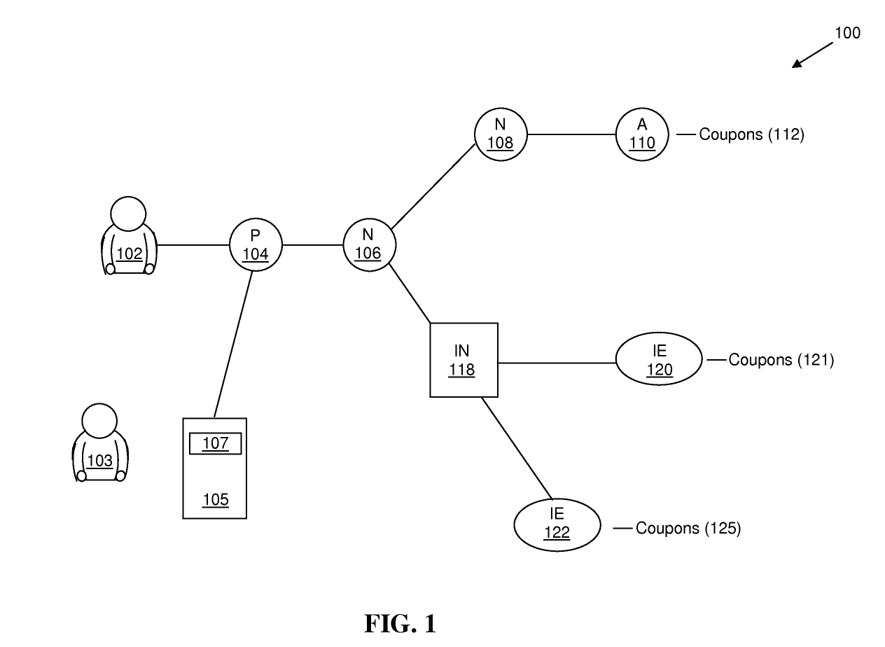

FIG. 1 illustrates one embodiment of a coupon delivery system. As shown in FIG. 1, the system 100 includes a variety of entities such as users 102 and 103, one or more manufacturers publishers 104, networks 106 and 108, and/or advertisers 110. The system 100 further includes one or more integrator networks (IN) 118 that have one or more integrated entities (IE) 120 and 122. The various entities including all the types of consumers and vendors described above, integrator networks and integrated entities illustrated in FIG. 1 are merely exemplary, and one of ordinary skill recognizes that the system 100 may include large numbers of entities. Moreover, the various entities are coupled together in different advantageous configurations such as, for example, the exemplary configuration illustrated in FIG. 1.

The user (e.g., a consumer) 103 accesses information and/or content provided by the server 104. One form of access may include a browser 105 that has inventory locations 107 for the presentation of providing descriptions of coupons. In one embodiment, a coupon posting is generated that requests approval of the proposed coupon by an authorizing party and then subsequent voting on the proposed coupon by other consumers and the authorization and posting of an authorized coupon such as 112, 120 and 121, for placement with the coupon inventory location 107. The corresponding coupon may be delivered to consumer 104 by one or more networks. For instance, in one example, the network 106 is coupled to the consumer 104, and the network 108 is coupled to the vendor 110. For this example, the networks 106 and 108 are coupled to each other. The consumer 110 may have one or more suggested coupons each comprising one or more coupons 112 that the consumer 110 wishes to have placed with the inventory of coupons such as, for example, the inventory location 107 of the consumer 104 that is presented to the user 103 via the browser application 105.

Alternatively, and/or in conjunction with the embodiments described above, some embodiments direct an ad call for the inventory 107 to an integrator network 118. In one example, the ad call is passed from the network 106 to the integrator network 118 with additional information such as, for example, a geographic location for the destination of the advertisement. In the illustration of FIG. 2, one ad call may have a destination of San Francisco (SF), while another ad call may have a destination of Los Angeles (LA). Based on the ad call and/or information, the integrator network 118 selectively responds to ad calls for, or on behalf of, one or more of its integrated entities 120 and/or 122. The integrated entities 120 and 122 generally include third party entities, such as advertisers, that transact on the exchange by using an intermediary, such as the integrator network 118.

The client system may include a desktop personal computer, workstation, laptop, PDA, cell phone, any wireless application protocol (WAP) enabled device, or any other device capable of communicating directly or indirectly to a network. The client system typically runs a web browsing program that allows a user of the client system to request and receive content from server systems over a network. The client system typically includes one or more user interface devices (such as a keyboard, a mouse, a roller ball, a touch screen, a pen or the like) for interacting with a graphical user interface (GUI) of the web browser on a display (e.g., monitor screen, LCD display, etc.).

The determination of the value of a coupon and whether or not a vendor will authorize a particular coupon may be done by a rally or a vote. To rally or vote on a coupon simply means that instead of each customer creating their own coupon as a registered user, the customers agree to utilize an existing user's coupon that is pending approval.

Also, registered users of the site have the ability to invite their friends to rally behind their coupons via electronic communications. This could be a post to a social network, an e-mail, a mobile text, etc.

Once the invited user arrives at the site, before they can rally behind the deal, they must be logged in. This means that the users need to be registered as a user of the site. Once they are registered, they have the ability to rally their friends' coupons or create their own.

Another important aspect of the technology to note is that when a user searches the site for a desired merchant, if he or she is not able to find the desired store, they do have the ability to add a merchant. Once the merchant's been added to the site, the user then has the ability to suggest a coupon for that desired merchant.

And last but not least, the site could additionally contain approved coupons which have been added to the site directly from the merchants.

There is a particular need in the coupon industry for providing mechanisms for identifying clear value among coupon users and awarding established value for creators/providers of coupons on-line. There is also a desire to be able to identify “click fraud” where on-line providers receive payments for the number of users that click-on their advertising, and individuals repeatedly click on specific ads to elevate the numbers of clicks per advertisement or coupon and yet those clicks are valueless. Some of these issues can be addressed by additional technology included with the underlying practices of the present technology by software implementation to the apparatus and systems already described herein.

The use of “consumer quality scoring” services provides two significant underlying services to the technology described herein. Consumer quality scoring is an analysis of the actual performance of users within the present system. A scholastic (e.g., 1-10, based on established criteria) or percentage score (as later defined) is used to classify the quality of the user. One significant basis for characterizing “quality” for a user is a rate determination with respect to on-line coupons or on-line advertising both clicked on and utilized. For example, an on-line user who clicked on seven advertisements or seven coupons and used three of those seven accessed items to purchase through those advertisements and/or use those coupons could be groups in a class artificially referred to herein as 3/7, 4.3, 4,3a or a scholastic rating of 4 (indicating a relatively low level of click-on usage (7 click-ons) but a significant rate utilization of the services accessed on-line. 3/7 is a specific identifier, 4.3 is an artificial scholastic rating approximating a 43% use rate of clicked on services, and 4.3a shows a similar utilization rate in a low volume category (e.g., a is fewer than 10 clicks/period, b would be 11-20 clicks for the same period, c would be 21-40, d 41 through 70, etc.) These types of categorizations of actual, scholastic, percentages of utilization tied to volume of use can be used to characterize or grade the quality of the user and/or the coupon or advertisement.

For further example, if a coupon is clicked on 1 million times and only 3 coupons are used, that would tend to indicate a low quality rating for the coupon, and might be indicative of click fraud, as described herein. A coupon with only 10,000 clicks but 400 users indicates a service that is of identifiable value to the service provider. The low level of total usage may reflect positioning of the advertisement on a particular venue and might further be used as an indicator that the improvement of the positioning might result in a further increase of clicks on a service with a respectable use rate.

This type of coupon or advertising providing format provides the advertiser greater visibility on the type of traffic (customer) they are bidding on in their on-line activities. This can be used in pricing or payment formats because of the easier identification of values and quality associated with specific service presentation and use and users.

This type of system also shows the advertiser whether or not the customer has a history of just clicking on ads but not buying or clicking on an ad and actually completing a purchase.

One way of describing the functioning of this process implementation on the apparatus or system described herein is as follows.

All registered users of the advertising network are given an initial quality score (e.g., for purposes of discussion this may be considered as a score of one (1)). Quality scores are based on a user's click or rally with respect to purchase history. If a user clicks on an ad or rallies a coupon and completes a purchase their quality score will go up accordingly. If a user clicks or rallies and ad and doesn't complete a purchase the users quality score will go down with respect to the initial, provisional score (in this case one was used as the example).

The uses and advantage of having a high quality score on the network is that the higher quality score gives the user more credibility and a higher probability a creator's or merchandiser's coupons will be approved. Furthermore, merchants or advertisers would be more willing to give the higher quality scoring on-line users exclusive offers and deeper discounts.

Another use of this additional technology is establishing a payment basis for coupon creators. These creators would be more active within the framework of the system if there were a basis for establishing not only a high rate of clicks on their proposed coupon, but also a determinable rate of usage of the coupons, establishing higher value to the merchandiser or provider. This can be done on the basis of specific qualities of advertisements being oidentified by one or more features such as percentage of users exercising the service (buying through the advertisement or using the coupon in a transaction), the percentage or volume of high quality score users accessing the advertisement or coupon, and the like.

The method, apparatus, system and computer readable medium described herein may also include quantification of quality of on-line communicators accessing coupons on a basis of comparing relative proportions of coupons used in a transaction by a specific on-line user as compared to a total number of coupons accessed by the specific user.

Coupon Delivery by Phone or PDA.

It is now commercially available delivery technology to have the coupons delivered to cell phones and/or PDAs or other hand-held devices having a viewing screen by such technologies as Delivery of tickets to mobile phones can be done in a variety of ways:
Text messaging (SMS)—visual inspection or OCR
Text messaging with WAP Push—visual inspection or OCR
Picture messaging (SMS, EMS, WAP Push and MMS)—usually uses a barcode, amd especially a 2D or 3D bar code
Dedicated Mobile application—which can store and render barcodes delivered via SMS, GPRS, Bluetooth, IRDA or RFID. Barcodes rendered on the device by a dedicated application have the advantage of being full screen without clutter, meaning faster and more successful scanning. A dedicated mobile application can also help the user to organise and sort their tickets better than when an SMS or MMS inbox is full of similar tickets, which is especially useful for transport tickets.
Device RFID—This is the method proposed under the Near Field Communication (NFC) specification but not yet in general use

Among the available commercial technologies that can effect this delivery of coupons according to the disclosed technology of the present invention include the following technologies now available for airline ticket delivery:

Solutions

| | Delivery | Scanning | Validation | | | |
|---|---|---|---|---|---|---|
| Company | Method | Method | Method | Advantages | Disadvantages | Location |
| Bissano | Barcode-based | Barcode scanner, | | The solution includes | Investment for | Offices: |
| Software ltd | EMS or MMS. | integrated thermal | | Barcode 1D and 2D | scanner devices. | Sofia/Bulgaria, Brisbane/Australia |
| | The solution | printer. | | and PDA software | | |
| | includes Barcode | | | and Back Office | | |
| | 1D and 2D. | | | system. PDA | | |
| | | | | communicate with | | |
| | | | | BO via WiFi/GPRS | | |
| | | | | connection. The | | |
| | | | | solution is used to | | |
| | | | | sales tickets on | | |
| | | | | move. | | |
| Mobile Tickets | In-Mobile | Providers of the | Remote or | World wide delivery | Consulting on | Offices based in London (UK), |
| Ltd | Application, | first ever Twitter | local server . . . | possible, secure & | Mobile Tickets, | with partners in Europe, Asia and |
| | Barcode 1D and | to Mobile | also working | customizable | Banking and | North America |
| | 2D delivered via | Barcode delivery | on Mobile | | Payments, also | |
| | secure encrypted | solution | Tickets in | | offering | |
| | SMS or GPRS, | | Facebook | | solutions for the | |
| | using a 3 kb Java | | App | | purchase of | |
| | Platform | | | | turnstiles, | |
| | | | | | scanner and | |
| | | | | | kiosk equipment | |
| | | | | | required for | |
| | | | | | Mobile | |
| | | | | | Ticketing | |
| bCode | Text-based SMS. | Electronically | Remote or | Secure, reliable, | Investment for | Australia, United States |
| | | (camera). | local server. | strong device | scanner devices. | |
| | | | | support, dynamic | | |
| | | | | user experience. | | |
| codeREADr | Barcode: 1D and | Embedded data | Remote | Secure, fast. For | Requires iOS, | Worldwide. |
| | 2D print or | validated on- | server. | budget-conscious | Android or BB | |
| | mobile. | device or online. | | (scanner already in | device at point | |
| | | | | pocket). | of entry. | |
| Eagle Eye | Text-based SMS | Customer types | Central | Secure real time | Integration into | Worldwide. |
| Solutions | as response to | unique code into | server lookup | redemption of ticket. | Chip and PIN | |
| Limited | text in, text push, | kiosk, PDA or | utilising | Capture of significant | system. PDA or | |
| | WAP Purchase. | Chip and PIN | either internet | customer data. | kiosk rental | |
| | | handset. | or existing | Utilises existing Chip | costs. | |
| | | | financial | and PIN technology | | |
| | | | networks. | for ticket code | | |
| | | | | capture and data | | |
| | | | | transfer. Unique and | | |
| | | | | multi use tickets | | |
| | | | | available. | | |
| GEAR.it | Barcode-based | Codes validated | Remote or | Secure, live voucher, | Rental of or | Italy |
| | MMS, SMS, | with | local server. | integrated marketing | investment for | |
| | Email. | mBARC/Newland | Integration | services, fraud | scanner devices. | |
| | | scan engine. | with | prevention, API | | |
| | | | proximity | integration into | | |
| | | | couponing | existing systems | | |
| | | | via Bluetooth | | | |
| | | | own servers. | | | |
| Gavitec AG | Barcode-based | EXIO & MD-20 | Remote or | Secure, wide-reach, | Rental of or | Worldwide |
| | SMS, EMS or | barcode scanners. | local server. | strong device | investment for | |
| | MMS. | | | support, integration | scanner devices. | |
| | | | | with ticketing, CRM | | |
| | | | | and access | | |
| | | | | management | | |
| | | | | solutions. | | |
| Impact Mobile | Barcode-based | Off-the shelf | Remote or | Secure. API to | No visual | |
| | SMS | image scanner. | local server. | integrate to existing | validation. | |
| | w/WAPpush or | | | ticketing solutions | Investment for | |
| | MMS. | | | | scanner devices | |
| | | | | | Problem with | |
| | | | | | several phone | |
| | | | | | models. High | |
| | | | | | telecom costs of | |
| | | | | | MMS messages. | |
| INA Finland | Text-based SMS | Visually/ | INA secure | No investment for | Investment in | Tampere, Finland. (service |
| | w/WAPpush. | validators. | server and/or | scanner devices, | scanner devices | worldwide) |
| | | | local server. | although | required if | |
| | | | | implementation | existing units | |
| | | | | possible. Secure | cannot be used. | |
| | | | | control code system | | |
| | | | | for visual validation, | | |
| | | | | optional | | |
| | | | | extra verification by | | |
| | | | | phone. No settings or | | |
| | | | | pre-registration | | |
| | | | | needed, single SMS | | |
| | | | | Secure and easy. | | |
| InMoDo (M- | Text-based SMS, | Imager/Camera- | Remote or | Secure, reliable, strong | Investment in | Sweden, Europe, worldwide |
| PhaTic) | barcode 1D and | based scanners. | local server | device support, range | scanner devices | |
| | 2D, RFID | | as ticket code | of scanner for | required if | |
| | | | contains full | different use-cases, | existing units | |
| | | | information | including handheld | cannot be used. | |
| | | | | units from well- | | |
| | | | | known brands, no | | |
| | | | | phone settings or pre- | | |
| | | | | registration required, | | |
| | | | | single SMS. | | |
| Liquid | Barcode. (SMS, | Off-the shelf | Remote or | World wide delivery, | — | Norway |
| Barcodes | MMS, WAP, | barcode scanner | local server | secure, visual ID | | |
| | NOKIA | | | included, optimised | | |
| | SMART, EMS). | | | 1D and 2D barcodes | | |
| | Airline Tickets/ | | | tailored to the mobile | | |
| | 2D Barcode | | | to ensure successful | | |
| | | | | scanning | | |
| Masabi | Dedicated mobile | Any 2D barcode | Encrypted | Secure ticket | Mobile | United Kingdom, Worldwide |
| | application, | scanner, including | barcode | purchase and | application must | deployments |
| | usually Java | using other | contents | delivery from the | be installed on | |
| | Platform, Micro | mobile phones as | enable off- | mobile, without any | phone by the | |
| | Edition, barcode | the inspection | line | sign-up process or | user or the | |
| | tickets delivered | device | validation | passwords. More | operator | |
| | via encrypted | | without | reliable barcode | | |
| | SMS or GPRS | | synchronising | scanning because of | | |
| | | | ticket | full-screen rendering | | |
| | | | databases | of the barcode. | | |
| | | | onto the local | Barcodes delivered in | | |
| | | | scanner, or | a single SMS. | | |
| | | | on-line | | | |
| | | | validation. | | | |
| Micket Mobile | Barcode-based | Handheld QR | Remote or | Integration with | Rental of or | Worldwide |
| Ticket | SMS, MMS. | code scanners. | local server. | Facebook, Twitter. | Investment for | |
| | Encrypted/Plain | | | Secure and | scanner devices. | |
| | text QR code. | | | Encrypted, Mobile | | |
| | | | | and Event Ticketing | | |
| | | | | Solutions | | |
| MBO | Barcode-based | Off the shelf | Remote or | Secure, live voucher, | Investment for | |
| | SMS, MMS, | image scanner/ | local server | integrated marketing | scanner devices. | |
| | WAP. Keyword | visually | | services, fraud | | |
| | Text- | | | prevention, API | | |
| | In/Push/WAP | | | integration into | | |
| | Purchase/Secure | | | existing systems | | |
| | Interfaces | | | | | |
| Mobimatics | Barcode SMS | M-Scan Validator | Caching | Removal of human | Investment for | |
| | 1D, 2D | 1D, 2D barcodes | GPRS | visual validation, | scanner devices. | |
| | | on mobiles | manifest | total fraud | | |
| | | | downloads | prevention. | | |
| | | | stored on | | | |
| | | | local devices. | | | |
| Mobiqa | Barcode-based | Off-the shelf | Remote or | Secure, wide-reach, | — | Worldwide |
| | SMS, WAP Push | barcode scanner. | local server. | visual ID included, | | |
| | or MMS. | | | optimised barcode | | |
| | | | | tailored to the mobile | | |
| | | | | to ensure successful | | |
| | | | | scanning | | |
| Moo! Mobile | Barcode-based | 2D barcode | Remote or | Integrated branding | Phone model | Netherlands, Worldwide |
| Technology | SMS, EMS, | scanner | local server | and marketing | required | |
| | Nokia Smart, | | | solution. Worldwide | | |
| | WAP Push or | | | delivery. API | | |
| | MMS | | | available. Secure. | | |
| MogoTix | QR code-based | Validated using | Remote or | Self-service | iPhone or | Worldwide |
| | ticket delivered | MogoTix iPhone | local server | ticketing; event | Android phone | |
| | through SMS | or Android apps | | organizers can sign | required to scan | |
| | | | | up to quickly sell | tickets | |
| | | | | mobile tickets to | | |
| | | | | events | | |
| NTT DoCoMo | Online purchase, | RFID reader | Online | Secure RFID system | Not usable for | |
| (Osaifu-Keitai) | downloaded to | (PaSoRi) | lookup | without visual | non-compliant | |
| | RFID chip | | | scanning. | phones. Credit | |
| | (Mobile FeliCa) | | | | card registration | |
| | | | | | needed. Still | |
| | | | | | often uses paper | |
| | | | | | ticket for | |
| | | | | | confirmation. | |
| Plusdial | SMS text | Visually (naked | Remote or | Patented control code | Investment for | Worldwide |
| | message (one | eye) or validators | local server. | system for visual | scanners needed | |
| | SMS is enough, | reading textual | | validation, tested | (but only if | |
| | no need for e.g. | content | | with 2 optional | automatic | |
| | binary SMS to | | | scanner/validator | validation is | |
| | carry bar codes) | | | systems. Operated | required). | |
| | | | | since 2001 with over | | |
| | | | | 60 million tickets | | |
| | | | | sold. No investment | | |
| | | | | needed when using | | |
| | | | | visual checking. As | | |
| | | | | textual SMS used, | | |
| | | | | system works in all | | |
| | | | | mobile phone models | | |
| | | | | without registration | | |
| | | | | or even data settings | | |
| | | | | requirements. Fixed | | |
| | | | | and handheld | | |
| | | | | scanners available; | | |
| | | | | even an Android | | |
| | | | | smart phone with | | |
| | | | | camera and | | |
| | | | | downloadable | | |
| | | | | software can be used | | |
| | | | | as handheld | | |
| | | | | validator. | | |
| ScreenTicket | SMS with link | PCT patent | Remote | On Device | None | Global, based out of Denmark |
| | delivered to web | pending On | server, data | Verification ®, global | | |
| | based mobile | Device | necessary | delivery, easy | | |
| | tickets and | Verification ® | | integration of API, | | |
| | coupons, all | and dynamic | | fast setup, secure | | |
| | options available | elements on | | solutions | | |
| | | tickets and | | | | |
| | | coupons. No | | | | |
| | | scanners needed | | | | |
| ShowClix | Delivers tickets | Off-the shelf | Remote | Rental of or | — | United States |
| Ticketing LLC | via SMS text | image scanner | server | investment for | | |
| | message | | | scanner devices | | |
| Sincoda | 2D barcode | 2D barcode, NFC | Online | Open system - can | | United Kingdom |
| Limited | creation, delivery | or RFID via | lookup via | integrate with any | | |
| | and redemption. | Sincoda terminal, | GPRS or | coupon/ticket/loyalty | | |
| | Content sent via | optional printer | WiFi, local | programme. Secure | | |
| | WAP and | dock. Customised | database or | RFID/NFC reader | | |
| | embedded email | version for car | custom | with dual SAM slots. | | |
| | | parks | integration | Read paper and | | |
| | | | | mobile barcodes. | | |
| Skycore LLC | 2D barcode | Off-the-shelf 2D | Local or | Cross carrier (US), | Investment in | USA. Scalable worldwide with |
| | creation, | scanners and/or | Remote | end-to-end, | traditional 2D | connectivity. |
| | delivery, | smart phones | Server. | enterprise solution; | scanners or | |
| | authentication | authenticated to | | MMS specialist. API | smart phones. | |
| | and redemption. | scan/read 2D | | option. | | |
| | Content sent via | barcodes. | | | | |
| | SMS/WAP Push, | | | | | |
| | MMS and Email. | | | | | |
| Smartmachine | 2D-Barcode- | CCD-camera | Online or | Secure, strong device | Rental of or | Worldwide |
| | based SMS, | based barcode | local. | support, integration | investment for | |
| | WAP Push, | scanner, attached | | with ticketing, CRM | scanners needed. | |
| | MMS, 2D- | to an access | | and access | | |
| | Barcode via Mail | control reader or | | management | | |
| | to | built into a kiosk. | | solutions. | | |
| | BlackBerry/PDA, | | | | | |
| | NFC. | | | | | |
| Timoco | Barcode-based | Off-the shelf | Remote or | Secure, wide-reach, | Rental of or | Western Europe |
| | SMS, WAP Push | barcode scanner, | local server. | visual ID included. | investment for | |
| | or MMS. | custom built | | | scanners needed. | |
| | | barcode scanners | | | | |
| | | (1D, 2D) | | | | |
| Trinity Mobile | Barcode (SMS, | Barcode reader, | Online | Removal of human | Investment for | |
| Limited | MMS, WAP, | PDA or Kiosk | lookup, local | visual validation, | scanner devices. | |
| | NOKIA, EMS). | | server or | unique one time use | | |
| | Keyword Text- | | trickle fed | codes, total fraud | | |
| | In/Push/WAP | | PDA | prevention. Free | | |
| | Purchase/Secure | | database. | software | | |
| | Interfaces | | Wifi and | | | |
| | | | GPRS | | | |
| tyntec | Barcode. (SMS, | Any 2D barcode | Online, | Secure. Worldwide | Investment for | Worldwide |
| | MMS, WAP, | scanner | remote or | availability. Highest | scanner devices. | |
| | NOKIA | | local. | privacy protection | | |
| | SMART, EMS). | | | through end-to-end | | |
| | Airline Tickets/ | | | control over the | | |
| | 2D Barcode | | | entire GSM delivery | | |
| | | | | path. Strong device | | |
| | | | | support. Strategic | | |
| | | | | partnership with | | |
| | | | | IATA for mobile | | |
| | | | | boarding passes. | | |
| Pyrumas | Barcode. (SMS, | Any 2D barcode | Online, | Secure. Indian | Investment for | India, Bangalore, Chamrajpet. |
| Software Pvt. | MMS, WAP, | scanner | remote or | Connectivity. | scanner devices. | |
| Ltd | NOKIA | | local. | Highest privacy | | |
| | SMART, EMS). | | | protection through | | |
| | Airline Tickets/ | | | end-to-end control | | |
| | 2D Barcode | | | over the entire GSM | | |
| | | | | delivery path. Strong | | |
| | | | | device support. | | |
| Unwire | SMS, | Visual, code | Online, | No sign-up needed, | Investment for | Europe |
| | smartphone apps | lookup and | remote or | multiple payment | scanner devices | |
| | and mobile web | imager/camera- | local | methods, strong | | |
| | | based scanners | | device support, | | |
| | | | | highly flexible ticket | | |
| | | | | product types | | |
| Wayin | 1D and 2D | Off-the shelf, | Remote or | Secure, live voucher, | Investment for | South Africa |
| Solutions | Barcode-based | custom built | local server | integrated marketing | scanner devices. | |
| | message | barcode scanners | | services, fraud | | |
| | (SMS, MMS, | (1D, 2D) | | prevention, API | | |
| | EMS, WAP and | | | integration into | | |
| | EMAIL(Optional | | | existing systems, | | |
| | for | | | rental of scanner | | |
| | Smartphones). | | | units available (South | | |
| | | | | Africa Only) | | |
| WapOneline | SMS, WAP & | Premium and | Purchase | World wide delivery | Investment | Offices: Finland, USA, Latin |
| | Mobile Web | Standard Rate | Conf# or | possible, secure & | required for | America |
| | Interfaces | SMS Connections | Barcode | customizable | customization | |
| | | to 30+ Carriers | delivered to | | and messaging | |
| | | | handset | | service | |
| www.mTicket.- | Text base SMS | Handheld units | Remote or | White label solution. | Need to buy | EU base and soon Worldwide |
| co | 100% compatible | IPhone, Android, | local server | No phone settings or | IPhone, | Partner. DataTEK Group, Inc. - |
| | with all mobile | Motorola, Ikon. | validation, | pre-registration | Android, Ikon, | Romania. |
| | handsets. No | Smart camera | WiFi, 3G. | required, only | Motorola. | |
| | need additional | image scanner. | Easy | SMS.Secure, strong | | |
| | software to | | integration of | and reliable device | | |
| | install on the | | api. | support. | | |
| | phone. | | | | | |

Although this disclosure has specific content with regards to time frames, materials, components and the like, the claims should be interpreted as covering the generic concepts disclosed herein and not only the specific examples provided.

What is claimed:

1. A method of creating new on-line obtainable coupons comprising:
a first server enabling communication with a first class of third party on-line communicators;
the first server receiving proposed content on coupons from the first class of third party communicators;
the first server posting a list of the proposed coupons, with or without modification of the proposed coupons after receipt;
enabling access to a second class of third party communicators comprising businesses including at least vendors, stores, warehouses, and material suppliers;
allowing members of the second third party communicators to approve or disapprove of proposed coupons that are dedicated to business of the second third party communicator;
posting any second third party communicator approved coupons; and
allowing all on-line communicators access to approved coupons so that any of on-line communicators may access downloadable or printable forms of approved coupons;
wherein the method also includes quantification of quality of on-line communicators accessing coupons on a basis of comparing relative proportions of coupons used in a transaction by a specific on-line user as compared to a total number of coupons accessed by the specific user.

2. A computer readable medium that stores instructions, which when executed by a computer, causes the computer to deliver a coupon online, said instructions to the computer for:
storing information, into a coupon delivery system,
to specify at least one specific vendor and/or or product for a coupon,
to allow at least one computer to accept form at least one consumer a suggestion online for at least one specific coupon desired by the consumer,
to allow the at least one computer to accept approval by the specific vendor or distributor or manufacturer of the product authorization to enable online access to the specific coupon, and
to allow online access to the at least one computer to download a coupon or verify access to the coupon for a consumer;
wherein a processor associated with the medium is configured to effect quantification of quality of on-line communicators accessing coupons on a basis of comparing relative proportions of coupons used in a transaction by a specific on-line user as compared to a total number of coupons accessed by the specific user.

3. A method comprising:
storing information on at least one processor in a coupon providing system;
the information allowing:
e) at least one unavailable coupon proposed by a consumer or vendor;
f) allowing consumers to provide commentary on a perceived desirability of the unavailable coupon;
g) allowing a vendor, supplier or manufacturer of a product described in the coupon to authorize availability of the coupon; and
h) upon receipt of authorization by the vendor, supplier or manufacturer, enabling online access for a download of the coupon or storing verification of availability of the authorized coupon when accessed by or on behalf of a consumer; and
wherein a processor in communication with the processor in the coupon providing system effects quantification of quality of on-line communicators accessing coupons on a basis of comparing relative proportions of coupons used in a transaction by a specific on-line user as compared to a total number of coupons accessed by the specific user.

4. The method of claim 3 wherein the quality of on-line communicators accessing coupons is used as a basis of measurement for determining value to be provided to the consumer or vendor proposing the unavailable coupon.

5. The method of claim 1 wherein delivery of a final coupon is effected by delivery of visible, scannable information to a hand-held communication device.

6. The method of claim 3 wherein delivery of a final coupon is effected by delivery of visible, scannable information to a hand-held communication device.

7. The method of claim 4 wherein delivery of a final coupon is effected by delivery of visible, scannable information to a hand-held communication device.

8. The medium of claim 2 wherein the processor in the coupon providing system is in wireless communication with a hand-held communication device and is configured to deliver data of visible, scannable information to the hand-held communication device.
